(19) United States
(12) Patent Application Publication
(10) Pub. No.: US 2024/0285076 A1
(43) Pub. Date: Aug. 29, 2024

(54) Modular Kit of Reusable and Repositionable Writing Surfaces and Category Indicators

(71) Applicant: Comsero, Inc., Thornton, CO (US)

(72) Inventor: Anthony Franco, Broomfield, CO (US)

(73) Assignee: Comsero, Inc., Thornton, CO (US)

(21) Appl. No.: 18/174,746

(22) Filed: Feb. 27, 2023

(51) Int. Cl. A47B 97/00; B43L 1/00

(52) U.S. Cl. CPC A47B 97/001; B43L 1/008

(57) ABSTRACT

A kit comprising at least a first erasable writing element wherein the erasable writing elements each having a surface adapted for writing upon with an erasable writing implement, and a non-adhesive surface for interconnecting to an existing solid surface. The kit further comprises a second element which can be used independently of the first erasable writing element or in combination thereof. The elements of the kit typically comprise a pliant layer having micro-suction elements adapted for removable interconnection to an existing structure or surface, and wherein a first element can be interconnected to the surface of a second element.

### CROSS REFERENCE TO RELATED APPLICATIONS

This application is a continuation-in-part of U.S. patent application Ser. No. 17/807,941 entitled MULTI-SIDED MODULAR ERASABLE WRITING PANEL AND SYSTEM FOR ATTACHMENT THEREOF and filed on Jun. 21, 2022, which claims the benefit of U.S. patent application Ser. No. 17/523,402 entitled MICRO-SUCTION REUSABLE AND REPOSITIONABLE WRITING SURFACES and filed on Nov. 10, 2021, which is a continuation of U.S. patent application Ser. No. 16/112,630 entitled MICRO-SUCTION REUSABLE AND REPOSITIONABLE WRITING SURFACES and filed on Aug. 24, 2018 (now U.S. Pat. No. 11,179,964), which claims benefit of the following provisional patent applications: U.S. Provisional Patent Application No. 62/561,581 entitled RETRACTABLE BOUNDARY APPARATUS AND SYSTEM and filed on Sep. 21, 2017; U.S. Provisional Patent Application No. 62/561,570 entitled DRY ERASE BOARD ERASER and filed on Sep. 21, 2017; U.S. Provisional Patent Application No. 62/561,568 entitled MODULARLY STACKABLE DRY ERASE PANELS AND SYSTEM THEREOF and filed on Sep. 21, 2017; U.S. Provisional Patent Application No. 62/561,559 entitled MULTI-ANGULAR RECONFIGURABLE HANGING APPARATUS and filed on Sep. 21, 2017; and U.S. Provisional Patent Application No. 62/561,550 entitled RECONFIGURABLE APPARATUS AND SYSTEM FOR MARKING AND DISPLAYING OF ITEMS and filed on Sep. 21, 2017. The entire contents of the foregoing applications are incorporated herein by reference in their entirety for all purposes.

### FIELD OF THE INVENTION

The present invention generally relates to an erasable writing element kit comprising a plurality of repositionable and reusable erasable surfaces. The erasable writing element kit comprises a plurality of erasable writing elements configured to interconnect with surfaces such as a wall, refrigerator, or other existing surface. The erasable writing elements allow a user to interconnect a writing surface to an existing surface for use in recording lists, notes, reminders, motivational words, sketches, and other written content.

### BACKGROUND OF THE INVENTION

Rewritable surfaces such as dry-erase surfaces, wet-erase surfaces, and chalkboards are used for many scenarios including collaboration, teaching, and documenting processes and procedures. Rewritable surfaces are typically limited to fixed surfaces or surfaces permanently mounted to a structure, or surfaces which are configured to be portable or to be carried.

Dry-erase technology typically involves the use of a non-permanent pen or marker which uses an erasable ink that adheres to a non-porous surface without binding or being absorbed by the surface. Wet-erase technology typically involves the use of markers or pens which use a quick-drying paste as their medium which results in a writing medium which can be erased with a damp cloth or running water for instance.

The nature of certain environments, such as for collaboration, follow practices which allow for participants to write their thoughts, typically in bold marker for purposes of visibility, on an adhesive backed piece of paper and adhere it to the wall wherein the paper is able to be moved and re-adhered to the wall as desired. Due to the nature of the pieces of paper, the paper cannot be erased and reused, and the adhesive backing reduces in grip each time it is removed from the wall. After use, the pieces of papers are documented and thrown in the trash or recycled. Similarly, paper elements with written word are used in and around the home and work environments for recording lists, memos, reminders, and other hand-written or hand-drawn information.

There is an identified need to provide a modular and reusable solution to allow users to alternatingly adhere to and remove an erasable writing element in relation to a desired existing surface such as a wall, refrigerator, or other surface commonly found in a home or office environment.

There is a further identified need to allow a user to alternatingly remove and adhere an erasable writing element in relation to a desired surface such as a wall to allow the user to modify the writing surface while it is removed.

There is a further identified need for a kit which includes multiple elements designed for use in a home or office environment for communicating lists, notes, tasks or the like.

### SUMMARY OF THE INVENTION

It is an aspect of certain embodiments of the present invention to provide a kit comprising erasable writing elements allowing a user to write on a surface with writing implements such as dry-erase or wet-erase markers wherein the writing surfaces are easily cleaned thereafter. The first side of the erasable writing elements in certain embodiments comprise a non-porous surface wherein a user can write, draw, or otherwise mark with an erasable writing implement.

It is an aspect of certain embodiments of the present invention to provide an erasable writing element wherein the erasable writing element is configured to be removably attached without adhesive to an existing surface. Certain embodiments of the kit discussed herein comprises a first erasable writing element, and a second erasable writing element configured to interconnect with the first erasable writing element to augment a user's interaction with the first erasable writing element. In certain embodiments the second erasable writing element comprises a category indicator to provide a grouping identifier such as types of groceries, or types of events such as a birthday or an urgent task.

In certain embodiments of the present invention, an erasable writing element comprises a layer comprising micro-suction elements such as those disclosed by U.S. patent application Ser. No. 17/523,402 to Franco (“Franco”), incorporated herein by reference for all purposes. Franco discloses micro-suction elements comprising air-tight microscopic caverns or microscopic cavities, wherein the microscopic caverns or microscopic cavities in a layer creates a suction which couples erasable writing element to an existing surface. In certain embodiments, the microscopic caverns or microscopic cavities are made air-tight with a flexible coating. In other embodiments, the microscopic caverns or microscopic cavities are formed in the porous layer and are air-tight without any coating. The micro-suction elements in the instant invention are typically configured to be used in shear wherein erasable writing element the erasable writing element is configured to be removably interconnected with an existing surface in a vertical orientation. However, alternate embodiments wherein the erasable writing element is interconnected with a non-vertical surface are within the spirit and scope of the present invention.

In certain embodiments a second side of an erasable writing element comprises micro-suction elements configured to removably interconnect an erasable writing element with an existing surface without diminishing the holding bond of the second side of the erasable writing element.

It is an aspect of certain embodiments of the present invention to provide an erasable writing element comprising a printed background to enhance or augment a user's interaction with the erasable writing element. In certain embodiments, guidelines are printed such as found on lined paper or a calendar. Alternate embodiments comprise printed images such as an ornamental image, or an outlined image encouraging a user to color in the image. Further embodiments including written word—such as a restaurant menu, grocery shopping list, written instructions, or musical score—are within the spirit and scope of the present invention.

It is an aspect of certain embodiments of the present invention to provide an erasable writing element comprising a geometric shape such as square or rectangle, or a decorative shape such as one mimicking an organic shape, fruit shape, vegetable shape, plant shape, animal shape, or other desired ornamental design.

It is an aspect of the present invention to provide multiple erasable writing elements adhered to a common backing sheet wherein a user can peel the erasable writing elements from the backing sheet as needed for interconnection to an existing surface. Preferred embodiments of the present invention comprise a plurality of identical erasable writing elements with a continuous surround.

It is an aspect of certain embodiments to provide an erasable writing element kit wherein the erasable writing elements contained therein comprise a pliant and flexible form wherein the erasable writing element can be adhered or interconnected to an existing surface having contours, such as the external surface of a refrigerator door.

It is a further aspect of the present invention to allow the user to interact with and modify printed background on the erasable writing element wherein the printed background provides guidelines for the user to write upon with a writing implement. It is a further aspect of the present invention to provide category indicators which exhibit written word or a representative icon. The category indicators of certain embodiments of instance, comprise written word or representative icons for categories such as food categories, meals, events, or other categories.

It is an aspect of certain embodiments to provide written instructions for the intended uses and interaction of a user with the erasable surfaces. It is a further aspect of the present invention to provide inspirational statements in the form of written word on an erasable surface.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1A—A front view of certain embodiments of the present invention

FIG. 1B—A front view of certain embodiments of the present invention

FIG. 1C—A front view of certain embodiments of the present invention

FIG. 2A—A front view of certain embodiments of the present invention

FIG. 2B—A side view of certain embodiments of the present invention

FIG. 2C—A detail view of the invention shown in FIG. 2B

FIG. 3A—A front view of certain embodiments of the present invention

FIG. 3B—A side view of certain embodiments of a writing implement

FIG. 3C—A front view of certain embodiments of the present invention

FIG. 4A—A front view of certain embodiments of the present invention

FIG. 4B—A side view of certain embodiments of the present invention

FIG. 4C—A detail view of the invention shown in FIG. 4B

FIG. 5A—A back view of certain embodiments of the present invention

FIG. 5B—A back view of certain embodiments of the present invention

FIG. 6A—A front view of certain embodiments of the present invention

FIG. 6B—A side view of certain embodiments of the present invention

### DETAILED DESCRIPTION OF VARIOUS EMBODIMENTS

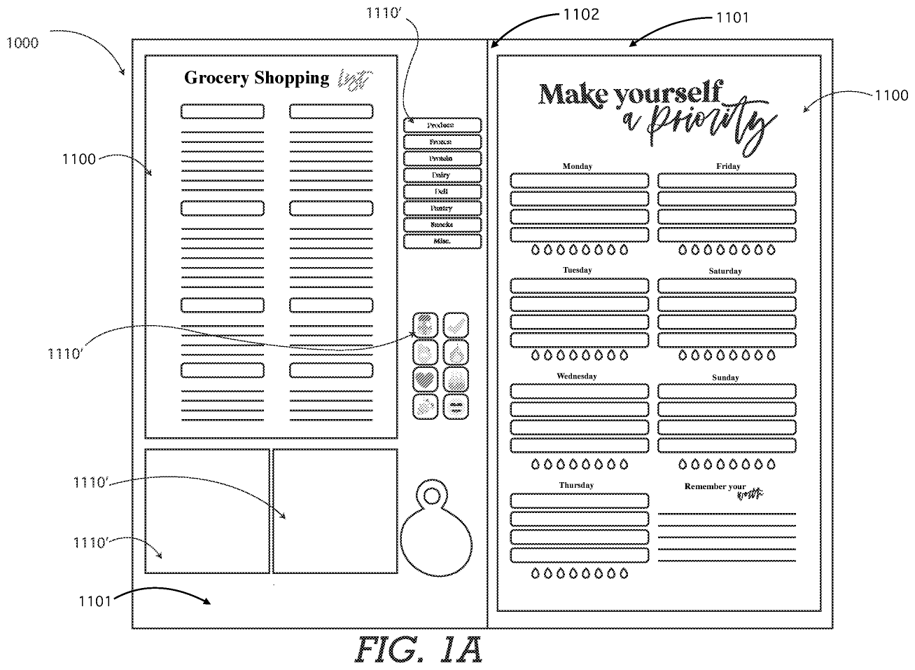

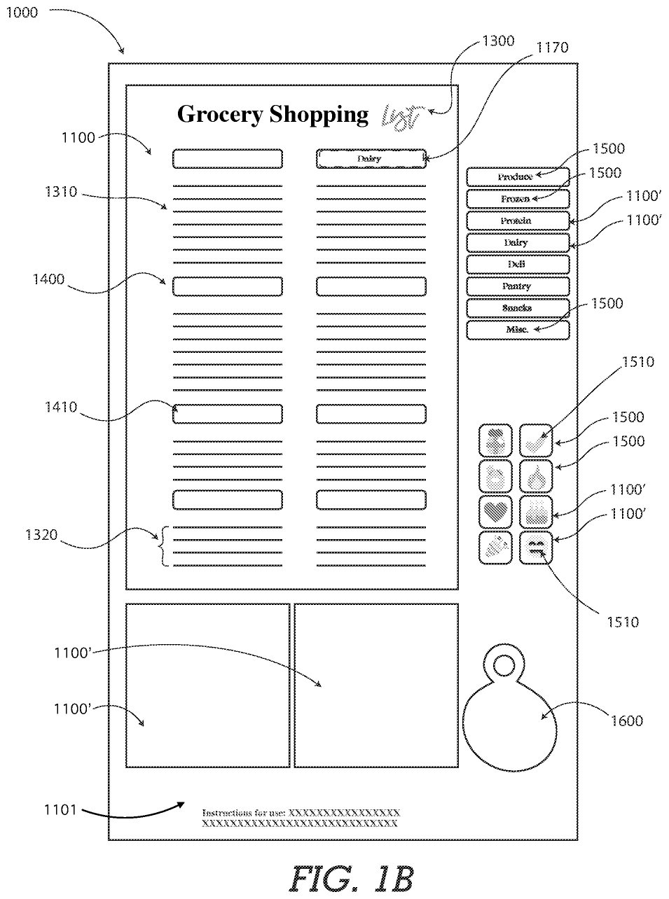

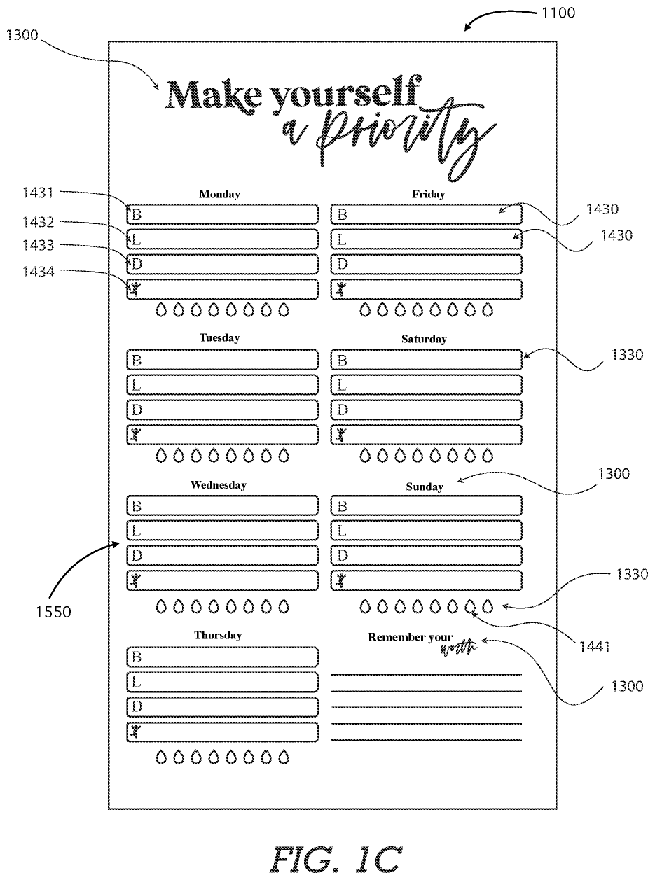

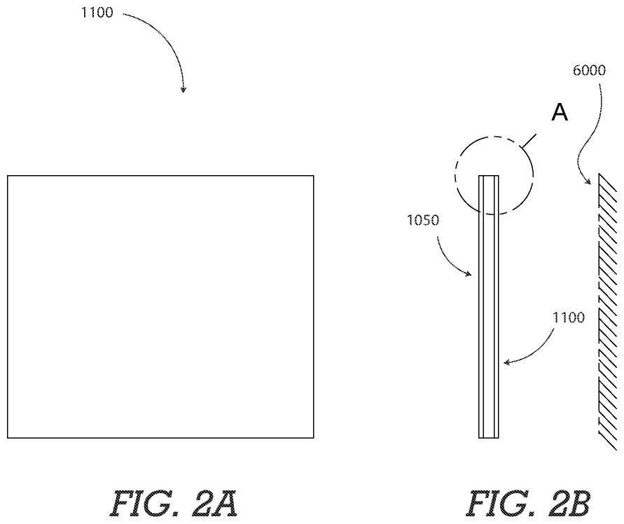

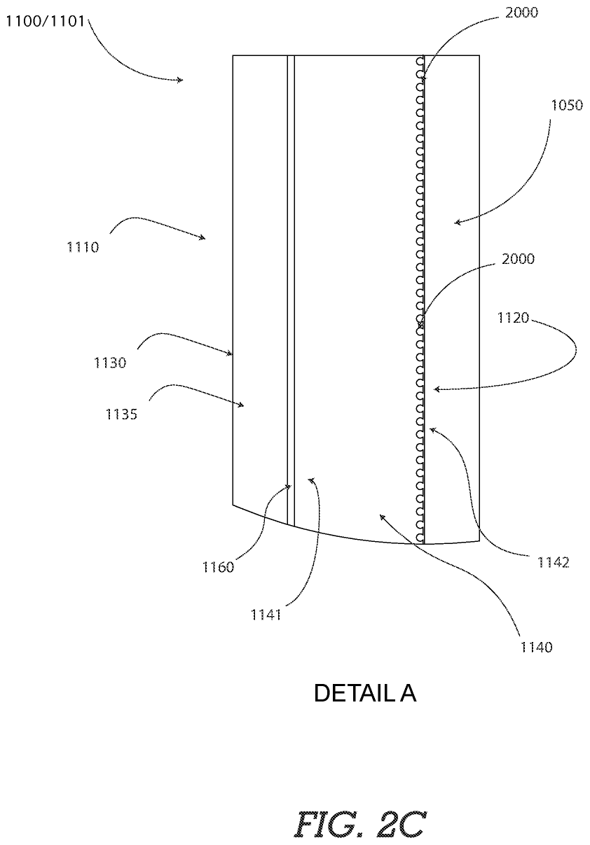

Certain embodiments of the present invention, as shown in FIG. 1A-FIG. 2C comprise a kit 1000 having at least one erasable writing element 1100 and surround 1101 interconnected to one side of a backing sheet 1050 wherein the erasable writing element 1100 is configured to be peeled from the backing sheet 1050 for use. The erasable writing element 1100 of certain embodiments comprises a surface 1130 on a first side 1110, such as a non-porous surface, adapted for writing upon with an erasable writing implement. Further, alternative embodiments omit the surround 1101.

As shown in FIG. 1B, surround 1101 provides a continuous enclosure around the perimeters of all the erasable writing elements 1100 of the kit 1000. In other embodiments, surround 1101 may enclose only a portion of the perimeters of the erasable writing elements 1100 of the kit 1000. For example, one edge of an erasable writing element 1100 may extend to the edge of the kit 1000.

In certain embodiments, as shown in FIG. 2C, the surface 1130 of surround 1101 is continuous with the surface 1130 of at least one erasable writing element 1100. As shown in FIG. 1B, the surface 1130 of surround 1101 is continuous with all erasable writing elements 1100, category indicators 1500, icons 1510, and writing implement storage devices 1600 of the kit 1000. The surround 1101 is configured to be peeled from the backing sheet 1050 to leave the at least one erasable writing element 1100 on the backing sheet 1050.

The kit 1000 may comprise one or more foldable axes 1102. The foldable axis 1102 may comprise a cut in or interruption of the surround 1101 which permits the backing sheet 1050 to be folded. The surround 1101 provides support for the erasable writing elements 1100, particularly when the kit 1000 is folded along foldable axis 1102. In the embodiment shown in FIG. 1A, the foldable axis 1102 bisects the kit 1000 into two portions of about the same size and shape so that the kit 1000 may be folded in half like a book.

In certain embodiments a second side 1120 of an erasable writing element 1000 is adapted for removably interconnecting with existing structures 6000. In certain embodiments a second side 1120 of an erasable writing element comprises micro-suction elements 2000 configured to removably interconnect the erasable writing element 1100 with an existing surface 6000 without diminishing the holding bond of the second side 1120 of the erasable writing element. In certain embodiments a second side 1120 of an erasable writing element comprises a reusable adhesive layer.

In certain embodiments, as shown in FIG. 1A-FIG. 2C for instance, a kit 1000 comprises a plurality of erasable writing elements 1100. A first side 1110 of the erasable writing elements comprises a non-porous layer 1135 adapted for writing thereon with an erasable writing implement, and a second side 1120 configured to be interconnected to an existing surface 6000. In certain embodiments the second side 1120 of the first erasable writing element comprises micro-suction elements 2000. In certain embodiments, the micro-suction elements comprise the structures disclosed by Franco. As desired a user may interconnect a first erasable writing element 1100 to an existing surface 6000, and interconnect one or more second erasable writing elements 1100′ to the first side 1110 of first erasable writing element 1100. Alternately, the user may interconnect the second erasable writing element 1100′ to the existing surface 6000 independent of the first erasable writing element.

In certain embodiments, the erasable writing element further comprises a pliant layer 1140 having a second side 1120 with a surface 1142 configured to interconnect with an existing surface 6000. In certain embodiments the surface 1142 comprises micro-suction elements 2000 therein for use in interconnecting the erasable writing element to the backing sheet 1050 and to an existing surface 6000 and/or another erasable writing element 1100. As used herein, the term “pliant” means that the layer or combination of layers is bendable and capable of generally conforming to contours of an existing surface 6000 and/or contours of a second erasable writing element 1100′. This pliant characteristic allows the surface 1142 to maintain a substantially continuous contact with existing surface 6000 and/or another erasable writing element 1100.

In certain embodiments, shown in FIG. 1B-FIG. 2C for instance, an erasable writing element 1100 and surround 1101 comprises a printable layer 1160 between the first side 1110 and the second side 1120, wherein the printable layer 1160 is viewable from the first side 1110 of the erasable writing element. In certain embodiments the printable layer 1160 is disposed between the first side 1110 and the second side 1120 wherein the non-porous layer 1135 is transparent. In alternate embodiments, the non-porous layer 1135 comprises printed matter 1300 embedded therein.

In certain embodiments, as shown in FIG. 1B-FIG. 1C for instance, the printed matter 1300 comprises a writing area 1310 where a user is encouraged to write on the erasable writing element. In certain embodiments a writing area 1310 comprises horizontal ruled lines 1320, while writing areas of alternate embodiments comprise the outline of a shape 1330, such as a square, circle, rectangle, or other geometric shape and wherein the user is encouraged to fill in the shape with an erasable writing implement in order to record an event or track progress towards a goal. For example, as shown in FIG. 1C, the printed matter 1300 comprises a plurality of tear drop shapes 1330 to symbolize a repeating event, i.e., the number of glasses of water the user is encouraged to consumed in a day, and the user may fill in a tear drop shape 1330 as each glass of water is consumed in order to keep track of the total number consumed.

In certain embodiments, as shown in FIG. 1A-FIG. 1C for instance, kit 1000 comprises a placeholder 1400 which comprises an area indicated by printed matter 1300 for interconnecting to an erasable writing element 1100. In certain embodiments, a placeholder 1400 comprises a shape 1410 having a profile matching the perimeter of an erasable writing element 1100′ as shown at 1170.

In certain embodiments, the placeholder comprises a category indicator 1500. A “category indicator” as used herein, refers to a second erasable writing element 1100′ intended for interconnection to a first erasable writing element 1100. A category indicator of certain embodiments comprises printed matter 1300 to indicate categorical identification for a user's input, such as a list. In certain embodiments the printed matter of a category indicator comprises written words such as grocery shopping categories including, but not limited to: “Produce”, “Frozen”, “Protein”, “Dairy”, “Deli”, “Pantry”, “Snacks”, and “Misc.”, as shown in FIG. 1B.

In certain embodiments, as shown in FIG. 1B for instance, a category indicator 1500 comprises a representative icon 1510 intended to represent a category through visual association. Embodiments of a category indicators include, but are not limited to, representative icons 1510 such as: a gift box, a check-mark, a grocery bag, a fire, a heart, a birthday cake, a party popper with confetti, and a smiley emoticon. In other embodiments, a category indicator comprises a surface 1130 on a first side 1110, such as a non-porous surface, adapted for writing upon with an erasable writing implement.

In certain embodiments, placeholders 1400 are intended for a user to write or mark on them or within their boundaries, while alternate embodiments of a placeholder 1400 are for the use of a category indicator 1500. Embodiments of placeholders 1400 comprise a variety of forms including, but not limited to: horizontal ruled lines 1320, geometric shapes 1330 such as rectangles, and rectangles with rounded corners.

In certain embodiments, as shown in FIG. 1C for instance, an erasable writing element 1100 comprises seven writing fields 1550, each writing field representing a day of the week Monday through Sunday. Each writing field 1550 comprises a plurality of horizontally oriented oblong placeholders 1430. A first oblong placeholder comprises a “B” 1431 therein to indicate an area for recording information surrounding breakfast activities, a second oblong placeholder comprises a “L” 1432 therein to indicate an area for recording information surrounding lunch activities, and a third oblong placeholder comprises “D” 1433 therein to indicate an area for recording information surrounding dinner activities. In certain embodiments, each writing area 1430 further comprises a fourth oblong placeholder with an icon 1434 indicating an area for recording daily exercise activities.

In certain embodiments a placeholder comprises a representative shape 1330 configured to allow a user to track daily habits. In certain embodiments the placeholder comprises a tear drop shape 1441. Certain embodiments comprise a plurality of placeholders having a tear drop shape intended for a user to track their hydration throughout a given day.

In certain embodiments of a kit, as shown in FIG. 1B and FIG. 3A-FIG. 6B, comprising at least one erasable writing element 1100, further comprises a writing implement storage device 1600 having a first side 1610 and a second side 1620, wherein the second side 1620 is configured to be interconnected to an existing surface 6000 such as drywall, painted drywall or other painted surface, metal, wood or wood composition, glass, stone or synthetic stone, plastic, a non-porous material, the first side 1110 of an erasable writing element, or other surface materials typically found in a home or office environment.

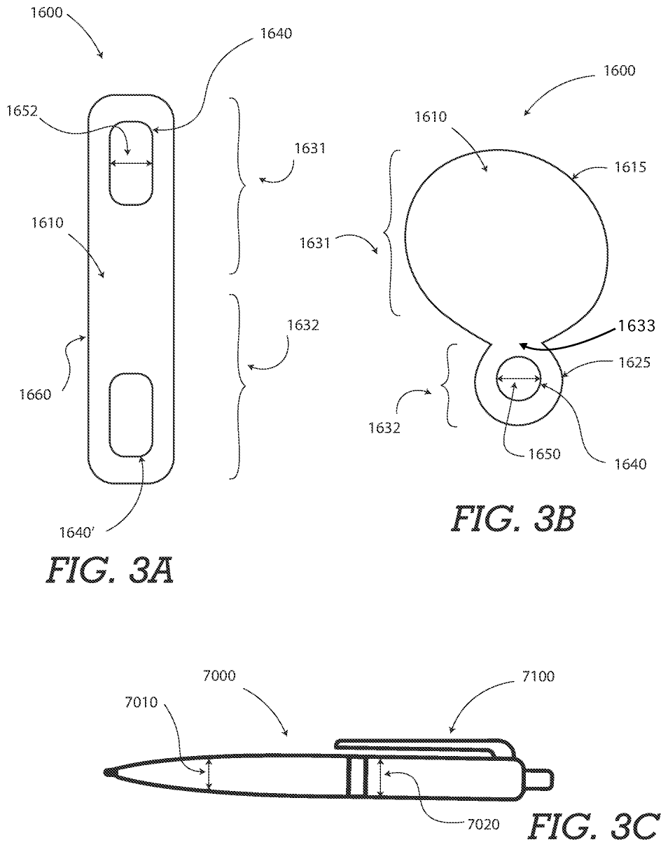

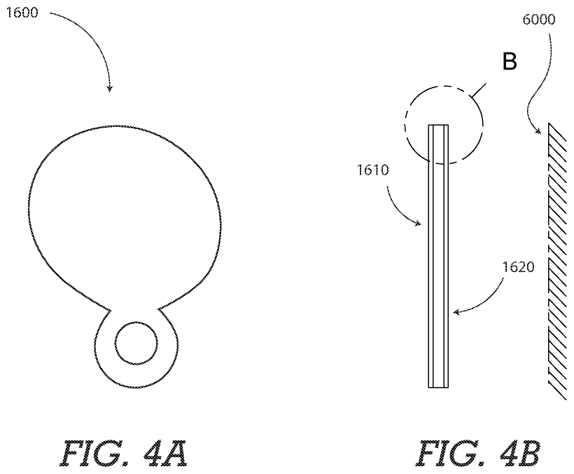

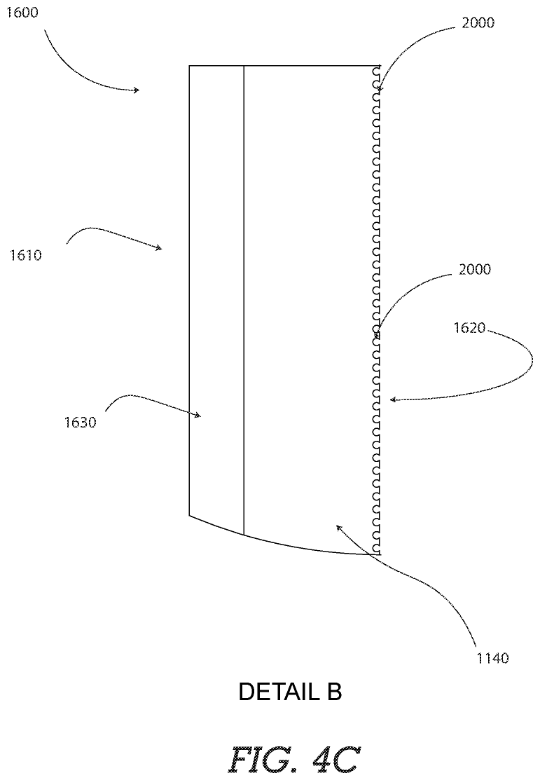

In certain embodiments, as shown in FIG. 3A-FIG. 4C, a first side 1610 of a writing implement storage device 1600 comprises a flexible membrane 1630. In certain embodiments, first side 1610 comprises a non-porous layer adapted for writing thereon with an erasable writing implement, and a second side 1620 configured to be interconnected to an existing surface 6000. In certain embodiments, implement storage device 1600 comprises a first portion 1631 and a second portion 1632, which are hingedly interconnected by intermediate portion 1633, wherein the second portion 1632 comprises an aperture 1640 therethrough. The aperture 1640 is configured to receive a writing implement 7000 therethrough, and constrain the writing implement 7000 therein. Interconnecting the first portion 1631 to an existing surface results in constraining the writing implement to the existing surface. In certain embodiments, the first portion 1631 is integral with at least one erasable writing element 1100. For example, the first portion 1631 may comprise a rectangular erasable writing element 1100 with the second portion 1632 interconnected to a lower edge of the erasable writing element 1100. In certain embodiments the aperture 1640 of the writing implement storage device is configured to receive a clip 7100 of the writing implement, thereby constraining the writing implement thereto.

In certain embodiments, as shown in FIG. 3B for instance, the aperture 1640 comprises a circular shape wherein the diameter 1650 of the aperture is greater than a first diameter 7010 of the writing implement, and a second diameter 7020 of the writing implement is greater than the diameter 1650 of the aperture. Thereby the writing implement 7000 is constrained within the writing implement storage device 1600.

In certain embodiments, as shown in FIG. 3A for instance, the aperture 1640 of the writing implement storage device comprises an oblong form wherein the width 1652 of the aperture is less the maximum 7050 diameter of the writing implement. When the writing implement 7000 is inserted through the aperture 1640, the oblong form of the aperture deforms wherein the width 1652. Of the aperture expands and allows the aperture 1640 to conform to the writing implement 7000 and constrain the writing implement therein.

In certain embodiments, a perimeter 1660 of the writing implement storage device comprises an oblong shape. However, writing implement storage devices of alternate embodiments comprising other shapes including regular geometric shapes, irregular geometric shapes, curvilinear shapes, rectilinear shapes, linear aspects, curvilinear forms, or a combination thereof are within the spirit and scope of the present invention.

In certain embodiments, a writing implement storage device 1600 comprises a first portion 1631 having a first aperture 1640, and a second portion 1632 comprising a second aperture 1640′ wherein the writing implement storage device 1600 can be used in a plurality of orientations. In certain embodiments, a first writing implement 7000 can be inserted through the first aperture 1640 and the second aperture 1640′ to store the writing implement. Alternately, a first writing implement 7000 can be inserted through the first aperture 1640, and a second writing implement 7000 inserted through the second aperture 1640′ to store two writing implements. Alternate embodiments including a plurality of apertures 1640 for storing a plurality of writing implements are within the spirit and scope of the present invention.

In certain embodiments, a writing implement storage device comprises a first portion 1631 comprising a curvilinear perimeter 1615, and a second portion 1632 comprising a curvilinear perimeter 1625. The second portion 1632 comprises an aperture 1640 therethrough. The aperture 1640 is configured to receive a writing implement 7000 therethrough, and constrain the writing implement therein. Interconnecting the first portion 1631 to an existing surface 6000 results in constraining the writing implement to the existing surface.

In certain embodiments, as shown in FIG. 4A-FIG. 4C, a writing implement storage device 1600 comprises second side 1620 comprises a pliant layer 1140 wherein the outer surface 1142 of the pliant layer comprises micro-suction elements 2000 such as micro-cavities. The micro-cavities 2000 are adapted to interconnect with non-porous surfaces such as found on certain existing surfaces 6000 or the first side 1110 of an erasable writing element.

In certain embodiments the second side 1620 of the writing implement storage device comprises an adhesive adapted for interconnecting with existing surfaces including porous surfaces such as dry-wall, masonry, and concrete.

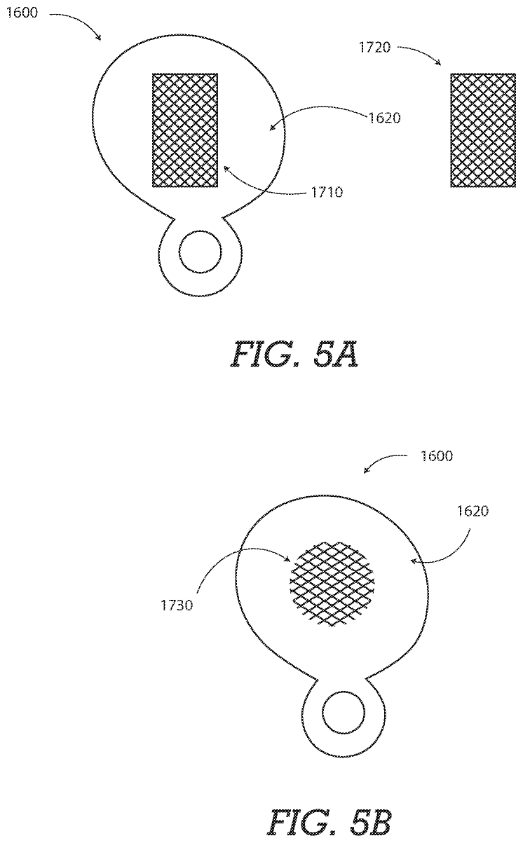

In certain embodiments, as shown in FIG. 5A for instance, the second side of the writing implement storage device comprises a first hook-and-loop fastener 1710. A second hook-and-loop fastener 1720 is interconnected with an existing surface 6000 wherein the first hook-and-loop fastener 1710 is configured to interconnect with the second hook-and-loop fastener 1720, wherein pressing the first hook-and-loop fastener 1710 to the second hook-and-loop fastener 1720 results in interconnecting the writing implement 7000 to the existing surface.

In certain embodiments, as shown in FIG. 5B for instance, the second side 1620 of the writing implement storage device 1600 comprises a magnet 1730 wherein introducing the magnet 1730 to an existing surface 6000 comprising ferromagnetic material results in the interconnection of the writing implement storage device to the existing surface.

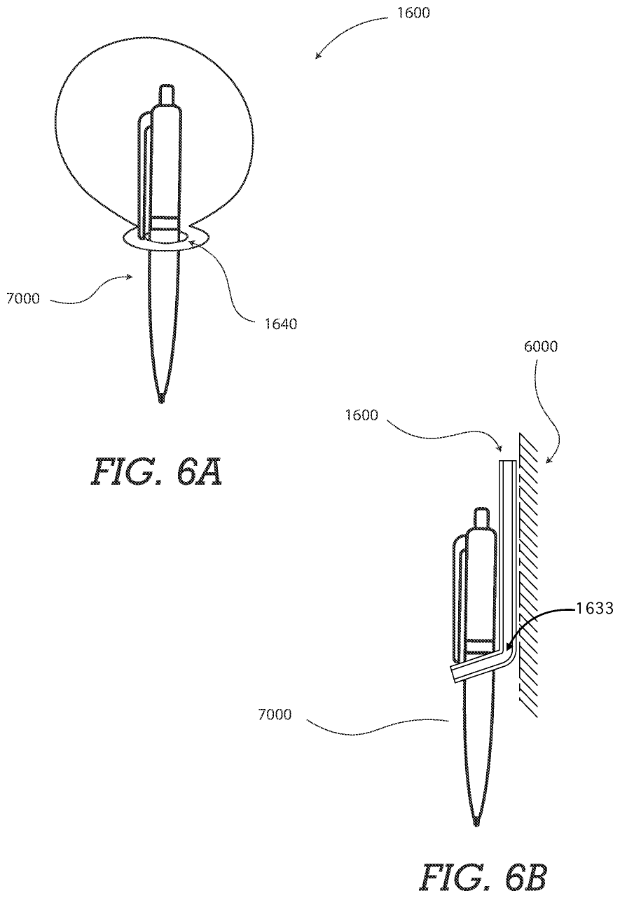

In certain embodiments, as shown in FIGS. 6A-6B, the pliant layer 1140 allows writing implement storage device 1600 to bend at intermediate portion 1633 so that the writing implement 7000 may be inserted through aperture 1640 while the first portion 1631 is interconnected to an existing surface. The weight of writing implement 7000 creates tension upon aperture 1640 which operates to maintain the implement in aperture 1640, even when the diameter of the writing implement 7000 is less than the diameter of first aperture 1640 and even when the writing implement 7000 lacks a clip or other protrusion to prevent passage of the writing implement 7000 through the aperture.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. An erasable writing element kit comprising:
a first erasable writing element comprising a pliant layer having a first side and a second side, the first side comprising a non-porous writing surface and the second side comprising a plurality of micro-suction elements;
a first category indicator comprising a perimeter and a pliant layer having a first side and a second side, the first side comprising a surface and the second side comprising a plurality of micro-suction elements;
a surround comprising a pliant layer having a first side and a second side, the first side comprising a surface and the second side comprising a plurality of micro-suction elements; and
a backing sheet having a first side;
wherein the second side of the first erasable writing element, the second side of the first category indicator, and the second side of the surround are removably interconnected to the first side of the backing sheet by the micro-suction elements;
wherein the micro-suction elements of the first category indicator are adapted to interconnect with the non-porous writing surface of the first erasable writing element;
wherein the surface of the surround is continuous with the non-porous writing surface of the first erasable writing element and the surface of the first category indicator.

2. The kit of claim 1, further comprising printed matter visible from the first side of the first erasable writing element.

3. The kit of claim 2, wherein the printed matter comprises a placeholder having a profile matching the perimeter of the first category indicator.

4. The kit of claim 3 wherein the printed matter of the first erasable writing element further comprises a plurality of horizontal ruled lines.

5. The kit of claim 3, wherein the first category indicator further comprises printed matter visible from the first side of the first category indicator.

6. The kit of claim 5, further comprising a second category indicator comprising a pliant layer having a first side and a second side, the first side comprising a surface and the second side comprising a plurality of micro-suction elements, wherein the second category indicator comprises a perimeter different from the perimeter of the first category indicator.

7. The kit of claim 6, wherein the second category indicator further comprises printed matter visible from the first side of the second category indicator.

8. The kit of claim 7 wherein the printed matter of the first category indicator is different than the printed matter of the second category indicator.

9. The kit of claim 8 wherein the surface of the surround is continuous with the surface of the second category indicator.

10. The kit of claim 1, further comprising a writing implement storage device comprising:
a pliant layer having a first side and a second side, the first side comprising a surface and a second side comprising a plurality of micro-suction elements;
a first portion adapted to interconnect to an existing surface; and
a second portion comprising an aperture configured to receive and hold a writing implement;
wherein the second portion is hingedly interconnected to the first portion; and
wherein the writing implement storage device is interconnected to the backing sheet.

11. The kit of claim 10 wherein the surface of the surround is continuous with the surface of the writing implement storage device.

12. An erasable writing element kit comprising:
a plurality of erasable writing elements, each comprising a pliant layer having a first side and a second side, the first side comprising a non-porous writing surface and the second side comprising a plurality of micro-suction elements;
a plurality of category indicators, each comprising a perimeter and a pliant layer having a first side and a second side, the first side comprising a surface and the second side comprising a plurality of micro-suction elements;
a surround comprising a pliant layer having a first side and a second side, the first side comprising a surface and the second side comprising a plurality of micro-suction elements; and
a backing sheet having a first side;
wherein the second sides of the plurality of erasable writing elements, the second sides of the plurality of category indicators, and the second side of the surround are removably interconnected to the first side of the backing sheet by the micro-suction elements;
wherein the micro-suction elements of the plurality of erasable writing elements are adapted to interconnect with an existing solid surface;
wherein the micro-suction elements of the plurality of category indicators are adapted to interconnect with the non-porous writing surface of the erasable writing elements;
wherein the surface of the surround is continuous with the non-porous writing surfaces of the plurality of erasable writing elements and the surfaces of the plurality of category indicators.

13. The kit of claim 12 further comprising a first folding axis.

14. The kit of claim 12 further comprising a writing implement storage device interconnected to the backing sheet and comprising:
a pliant layer having a first side and a second side, the first side comprising a surface and a second side comprising a plurality of micro-suction elements;
a first portion adapted to interconnect to an existing solid surface; and
a second portion hingedly interconnected to the first portion;
wherein the second portion comprises a first aperture configured to receive a writing implement therethrough.

15. The kit of claim 14 wherein the writing implement storage device further comprises a second aperture configured to receive a writing implement therethrough.

16. The kit of claim 12 wherein at least one of the erasable writing elements further comprises printed matter visible from the first side of the first erasable writing element.

17. The kit of claim 16 wherein the printed matter of the first erasable writing element comprises a plurality of placeholders.

18. The kit of claim 17 wherein at least one of the plurality of placeholders has a profile matching the perimeter of at least one of the plurality of category indicators.

19. The kit of claim 12 wherein the plurality of category indicators have at least two different perimeter shapes.

20. The kit of claim 17 wherein at least one of the plurality of placeholders is adapted to be filled in to record completion of a repeating event.
